(19) United States
(12) Patent Application Publication
(10) Pub. No.: US 2006/0121258 A1
(43) Pub. Date: Jun. 8, 2006

(54) Sol composition for dielectric ceramic, and dielectric ceramic and multilayered ceramic capacitor using the same

(75) Inventors: Yong Suk Kim, Kyungki-do (KR); Hyo Soon Shin, Kyungki-do (KR); Hyoung Ho Kim, Kyungki-do (KR); Ho Sung Choo, Kyungki-do (KR); Jung Woo Lee, Kyungki-do (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Kyungki-do (KR)

(21) Appl. No.: 11/052,796

(22) Filed: Feb. 9, 2005

(30) Foreign Application Priority Data
Dec. 7, 2004 (KR) 10-2004-102522

(51) Int. Cl. B32B 18/00; B32B 15/04

(52) U.S. Cl. 428/210; 428/469; 428/701; 428/702

(57) ABSTRACT

Disclosed herein is a sol composition for ultrathin dielectric ceramic films, and dielectric ceramic and a multilayered ceramic capacitor manufactured using the same. The sol composition, composed of BaTiO₃ as a main ingredient and an auxiliary ingredient, includes a polymeric sol having a metal precursor solution of BaTiO₃ and an organic solvent, and an organic additive dissolved in the organic solvent to act as the auxiliary ingredient, in which the amount of the organic additive corresponds to the required amount of the auxiliary ingredient of the dielectric ceramic. Further, the ultrathin dielectric ceramic film, which is manufactured by a sol-gel process, includes the auxiliary ingredient, and hence, is advantageous in making low temperature sintering possible, and having a high dielectric constant, a high sintered density, and TCC characteristic meeting the X5R of EIA standard.

### RELATED APPLICATION

The present application is based on, and claims priority from, Korean Application No. 2004-102522, filed on Dec. 7, 2004, the disclosure of which is incorporated by reference herein in its entirety.

### BACKGROUND OF THE INVENTION

1. Field of the Invention

The present invention relates generally to a sol composition for dielectric ceramic used in a chip component, and an ultrathin dielectric ceramic film and a multilayered ceramic capacitor (MLCC) manufactured using the same. More specifically, the present invention relates to a technique for manufacturing dielectric ceramic by use of a sol-gel process, instead of a slurry process, in which the dielectric ceramic includes an auxiliary ingredient to be added in an organic additive type to a sol.

2. Description of the Related Art

To fabricate light, slim, short and small electronic components with low fabrication costs and simplified fabrication processes, a dielectric material having a high dielectric constant, superior temperature characteristics of capacitance, and high reliability, must be developed. For this, ultrathin dielectrics are required. The chip component including ultrathin dielectric films is exemplified by MLCCs, chip inductors, EMI filters, LC filters, etc.

In a technique for forming a dielectric of a chip component into a thin film, in the case of an MLCC, a dielectric layer therein is formed of slurry comprising ceramic powder and other additives including, for example, an organic binder, an organic solvent, and a dispersing agent, by a tape casting process shown in FIG. 1. In the tape casting process, the ceramic slurry is applied on a carrier film through a die and then dried, to obtain a green sheet. Subsequently, an inner electrode pattern is printed on the green sheet, which is mainly performed by a screen printing process. The green sheets having printed electrodes are layered to a predetermined number, followed by being compressed, cut and sintered, to manufacture a multilayered ceramic sintered body.

Recently, with the aim of manufacturing an MLCC having ultrahigh capacitance, methods of forming the dielectric into a thinner film are needed. However, techniques of thinning a dielectric layer using a slurry process have reached their limit. For instance, even if the green sheet is formed to be thin, it is difficult to separate the green sheet from the carrier film. Moreover, in the MLCC, unevenness due to a step between a surface of the dielectric layer on which the inner electrode pattern is printed and a surface of the dielectric layer on which the inner electrode pattern is not printed may cause a pillowing phenomenon. Therefore, a novel technique for fabricating a thin dielectric film, which may substitute for a tape casting process, is required.

In this regard, Korean Patent Application No. 2003-91591 (corresponding to U.S. Ser. No. 11/011,092 (Your Ref.: 2336-380) hereinafter, referred to as ‘prior technique’) discloses a method of manufacturing an ultrathin dielectric ceramic film using a sol-gel process, in which not only a polymeric sol and a hybrid sol, but also a polymer-added polymeric sol and a polymer-added hybrid sol, resulting from addition of a polymer material to the above polymeric sol and hybrid sol to realize homogeneity of sol, are provided. In accordance with the prior technique, fabrication of an ultrathin dielectric film has succeeded due to spin coating using a sol-gel process. However, nowhere does the prior technique mention the addition of an auxiliary ingredient to increase the properties of the dielectric ceramic. Thus, the properties of the dielectric ceramic obtained by the prior technique need be improved.

### SUMMARY OF THE INVENTION

Accordingly, in order to improve the prior technique of manufacturing dielectric ceramic using a sol-gel process, an object of the present invention is to provide a sol composition, including an auxiliary ingredient by using an organic additive which is dissolved in a sol to achieve homogeneity of the sol.

Another object of the present invention is to provide an ultrathin dielectric ceramic film manufactured using the sol composition.

Still another object of the present invention is to provide an MLCC manufactured using the sol composition.

In order to accomplish the above objects, the present invention provides a sol composition for dielectric ceramic comprising BaTiO₃ as a main ingredient and an auxiliary ingredient, which comprises a polymeric sol including a metal precursor solution of BaTiO₃ and an organic solvent, and an organic additive dissolved in the organic solvent to act as the auxiliary ingredient, in which the amount of the organic additive corresponds to the required amount of the auxiliary ingredient of the dielectric ceramic.

In a preferable embodiment, the sol composition of the present invention is a sol composition for dielectric ceramic comprising BaTiO₃ as a main ingredient and at least one auxiliary ingredient selected from among 1-3 parts by weight of Si, 1-3 parts by weight of Mg, 0.5-2 parts by weight of Mn, 2-5 parts by weight of Y, and 0.05-2 parts by weight of Ca, based on 100 parts by weight of BaTiO₃, and such a sol composition is composed of a polymeric sol including a metal precursor solution of BaTiO₃ and an organic solvent, and at least one organic additive, acting as the auxiliary ingredient of the dielectric ceramic, selected from among an Si organic additive, an Mg organic additive, an Mn organic additive, a Y organic additive and a Ca organic additive, in which the amount of the organic additive corresponds to the required amount of the auxiliary ingredient of the dielectric ceramic.

In the present invention, the polymeric sol further comprises any polymer material selected from among polyvinyl pyrrolidone, polyacrylic acid, benzaldehyde, and p-hydroxy benzoic acid.

Also, the polymeric sol comprises 5-10 wt % barium acetate, 5-10 wt % titanium isopropoxide, 40-65 wt % alcoholic solvent, 15-30 wt % acetic acid, 3-10 wt % reaction stabilizer, and 0.5-5 wt % polymer material.

Alternatively, in the present invention, the polymeric sol may be replaced by a hybrid sol including the above polymeric sol and a particulate sol composed of ceramic powder of BaTiO₃ and an organic solvent. Preferably, the hybrid sol includes 55-45 wt % particulate sol and 25-45 wt % polymeric sol. The particulate sol consists of 20-40 wt % BaTiO₃ powder and 60-80 wt % alcoholic solvent.

In the present invention, the Si organic additive is selected from among tetramethyl orthosilicate, tetraethyl orthosilicate, silicon tetraacetate, and tetraethylsilane. The Mg organic additive is selected from among magnesium ethoxide, magnesium nitrate hexahydrate, magnesium acetate tetrahydrate, magnesium acetylacetonate dihydrate, magnesium bishydrate, magnesium citrate, and magnesium methoxide. The Mn organic additive is selected from among manganese acetate dihydrate, manganese (II) acetate, manganese (II) acetate tetrahydrate, and manganese (II) acetylacetonate. The Y organic additive is selected from among yttrium acetate hydrate, yttrium acetylacetonate, yttrium acetylacetonate hydrate, yttrium butoxide, yttrium 2-ethylhexanoate, yttrium isopropoxide, and yttrium isopropoxide oxide. The Ca organic additive is selected from among calcium acetate hydrate, calcium acetate monohydrate, calcium acetylacetonate hydrate, calcium tetramethyl heptanedionate, calcium citrate tetrahydrate, calcium cyclohexanebutyrate, calcium 2-ethylhexanoate, calcium isopropoxide, and calcium methoxide.

Further, the present invention provides dielectric ceramic, which is manufactured from the above sol composition. The dielectric ceramic is obtained by sintering a starting material for BaTiO₃ as a main ingredient and a starting material for an auxiliary ingredient, in which the starting material for the main ingredient is a polymeric sol including a metal precursor solution of BaTiO₃ and an organic solvent, and the starting material for the auxiliary ingredient is an organic additive dissolved in the organic solvent. In order that the auxiliary ingredient of the dielectric ceramic includes at least one selected from among 1-3 parts by weight of Si, 1-3 parts by weight of Mg, 0.5-2 parts by weight of Mn, 2-5 parts by weight of Y, or 0.05-2 parts by weight of Ca, based on 100 parts by weight of the main ingredient, the organic additive includes at least one selected from among an Si organic additive, an Mg organic additive, an Mn organic additive, a Y organic additive and a Ca organic additive, in which the amount of the organic additive corresponds to the required amount of the auxiliary ingredient of the dielectric ceramic.

Furthermore, the present invention provides a multilayered ceramic capacitor, which comprises a plurality of dielectric ceramic layers, inner electrodes formed between the dielectric ceramic layers, and outer electrodes electrically connected to the inner electrodes, in which each of the plurality of dielectric ceramic layers is formed of the above dielectric ceramic.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a tape casting process used conventionally;

FIG. 2 is a view showing a hybrid sol, according to the present invention;

FIG. 3 is a view showing a process of preparing the hybrid sol, according to the present invention;

FIGS. 4a and 4b are photographs showing cross-sections of dielectric ceramics, in which FIG. 4a shows dielectric ceramic having an auxiliary ingredient of Si and Mg, according to the present invention, and FIG. 4b shows conventional dielectric ceramic having no auxiliary ingredient;

FIG. 5 is a graph showing the temperature coefficient of capacitance (TCC) characteristic in the dielectric ceramic (including the auxiliary ingredient of Si and Mg), according to the present invention;

FIGS. 6a and 6b are photographs showing 10,000 and 50,000 magnifications, respectively, of cross-sections of the dielectric ceramic, according to the present invention; and

FIG. 7 is a graph showing TCC characteristic of the dielectric ceramic (including the auxiliary ingredient of Si, Mg, Mn, Y and Ca), according to the present invention.

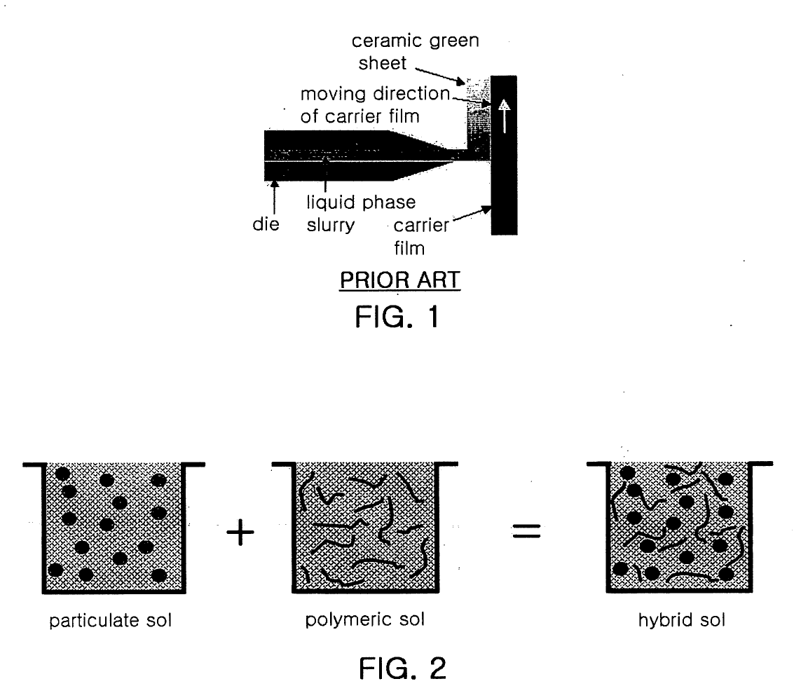

### DESCRIPTION OF THE PREFERRED EMBODIMENTS

Hereinafter, a detailed description will be given of the present invention, with reference to the appended drawings.

The present invention is intended to improve properties of an ultrathin dielectric ceramic film, resulting from a method disclosed in Korean Patent Application No. 2003-91591. The dielectric ceramic contains various auxiliary ingredients to make low temperature sintering possible and increase dielectric properties. The ceramic having a perovskite structure mainly used in multilayered ceramic capacitors (MLCCs), such as BaTiO₃, includes any auxiliary ingredient selected from among Si, Mg, Mn, Y, Ca, and combinations thereof. In the dielectric ceramic, a starting material for an auxiliary ingredient is commonly used in an oxide type. In addition to the above mentioned auxiliary ingredients, other auxiliary ingredients may be used in the present invention. Further, in BaTiO₃ as an ABO₃ type perovskite dielectric material, part or all of the fraction of Ba may be replaced by Sr or Ca, and part or all of the fraction of Ti may be replaced by Zr or Hf.

If the dielectric ceramic is manufactured by adding the above auxiliary ingredient to the sol of the prior technique, improvements of the properties due to the auxiliary ingredient may be expected. However, since the sol of the prior technique has no auxiliary ingredient, it has disadvantages, such as high sintering temperatures, a low dielectric constant, a low sintered density, and poor TCC characteristic. Thus, various auxiliary ingredients, for example, Si functioning to make the low temperature sintering possible, Mg functioning to increase the sintered density, and Mn, Y and Ca functioning to ensure the TCC characteristic, are used. In addition, the use of other auxiliary ingredients may be considered in the present invention.

As the present inventors have studied the addition of the auxiliary ingredient to the sol of the prior technique, they have reached the conclusion that to use the starting material for the auxiliary ingredient in an oxide type is undesirable. This is because oxides negatively affect the homogeneity of the sol, and may cause the formation of a secondary phase and pores in the dielectric ceramic. Therefore, from the results of many studies, the present inventors have found that addition of a liquid phase auxiliary ingredient to the sol realizes desirable

functions of the auxiliary ingredient in the dielectric ceramic in accordance with addition purposes thereof while maintaining the advantages of a sol-gel process.

The major characteristic of the present invention is that the auxiliary ingredient suitable for preparation of the dielectric ceramic by a sol-gel process is used in an organic additive type dissolved in an organic solvent of the sol, instead of an oxide type. In addition, the kind of organic additive with respect to Si, Mg, Mn, Y and Ca serving as representative auxiliary ingredients in BaTiO₃ based dielectric ceramic is determined, thereby realizing homogeneity of the sol and achieving the purposes of addition of the auxiliary ingredient in the dielectric ceramic.

Usable in the present invention, the sol composition is exemplified by a polymeric sol, a polymer-added polymeric sol, a hybrid sol, and a polymer-added hybrid sol, as disclosed in Korean Patent Application No. 2003-91591. Although various dielectric ceramic materials, in addition to BaTiO₃, are examined by the prior technique, the present invention focuses on BaTiO₃ of perovskite structure, as represented by ABO₃. Also, an organic additive acting as an auxiliary ingredient may be added to a sol composition of other dielectrics as well as BaTiO₃ based dielectrics. Below, the actually usable sol is described. A basic concept for such sol is shown in FIG. 2.

(1) Polymeric Sol

A polymeric sol, which is an admixture of a metal precursor solution of a dielectric material and an organic solvent, is a sol having polymers dispersed therein. In such a case, it is known that a preparation method of a polymeric sol includes, for example, an acetate process, an alkoxide process, and a hydroxide process. As for the acetate process, barium acetate is admixed with titanium isopropoxide. That is, barium acetate is dissolved in acetic acid and then stirred, to obtain a barium acetate solution, which is then added with titanium isopropoxide, to prepare a BaTiO₃ sol. The acetate process is advantageous because of low material prices and easy water control. As for the alkoxide process, barium alkoxide is admixed with titanium isopropoxide to obtain a BaTiO₃ sol. This process has the advantage of low pyrolytic temperatures. As for the hydroxide process, barium hydroxide is admixed with titanium isopropoxide to prepare a BaTiO₃ sol. This process is advantageous because of low pyrolytic temperatures and low material prices. In this way, the polymeric sol prepared by the acetate process, the alkoxide process or the hydroxide process may be used in the present invention. In particular, the polymeric sol prepared by the acetate process is preferably used. Further, any one selected from among barium acetate, barium alkoxide and barium hydroxide along with titanium alkoxide including titanium isopropoxide constitutes the metal precursor of the polymeric sol.

The polymeric sol of the present invention includes the metal precursor solution of the dielectric material and the solvent. At this time, it is preferable that the solvent be an alcoholic solvent. The alcoholic solvent is exemplified by 2-methoxy ethanol or ethanol. Also, the polymeric sol of the present invention further includes a reaction stabilizer, in which the reaction stabilizer functions to retard gelling of the sol so that the polymeric sol can be stored for a long period. The reaction stabilizer is selected from among diethanol amine, triethanol amine, acetylacetone, and combinations thereof. In the case where the dielectric material is BaTiO₃, the polymeric sol is composed of 5-10 wt % barium acetate, 5-10 wt % titanium isopropoxide, 40-65 wt % alcoholic solvent, 15-30 wt % acetic acid, and 3-10 wt % reaction stabilizer.

(2) Polymer-Added Polymeric Sol

The polymer-added polymeric sol results from adding a polymer material to the (1) polymeric sol, in which the polymer material includes a polymer compound having a molecular weight of 5,000-1,500,000. Such a polymer material is selected from among PVP (PolyVinyl Pyrrolidone), PAA (Poly Acrylic Acid), benzaldehyde, P-hydroxy benzoic acid, and combinations thereof.

In the present invention, the polymer-added polymeric sol includes 5-10 wt % barium acetate, 5-10 wt % titanium isopropoxide, 40-65 wt % alcoholic solvent, 15-30 wt % acetic acid, 3-10 wt % reaction stabilizer, and 0.5-5 wt % polymer material. At this time, barium acetate and titanium isopropoxide are admixed at a molar ratio of 1:0.98-1.02, and preferably, at an equal molar ratio of 1:1, to control the equivalents of barium titanate. Of the solvents, acetic acid functions as a chemical catalyst to cause the polymerization. If the reaction stabilizer is used in an amount outside of the range of the present invention, polymerization does not occur, and precipitation may take place. If the polymer material is used in an amount less than 0.5 wt %, the amount of polymer material is insufficient to act as a dispersing agent and a binder, and thus, optimal effects cannot result. On the other hand, if the amount exceeds 5 wt %, viscosity is excessively increased.

(3) Hybrid Sol

The hybrid sol means a sol having two or more kinds of colloidal particulates dispersed simultaneously therein, and comprises a mixture of particulate sol and polymeric sol, as shown in FIG. 2. In the present invention, the particulate sol comprises an admixture of ceramic powder of a dielectric material and an organic solvent, and is a sol having ceramic powder dispersed in the form of solid particulates. The organic solvent includes an alcoholic solvent, for example, 2-methoxy ethanol or ethanol. In the particulate sol, the ceramic powder is composed of BaTiO₃, and has a particulate size of 0.05-0.5 μm. Ceramic powder having a particulate size of less than 0.05 μm results in a high surface area, thus being difficult to disperse. On the other hand, if the size exceeds 0.5 μm, a non-uniform coating film results, and also, stability is lowered due to sedimentation.

The particulate sol of the present invention comprising the admixture of the ceramic powder of the dielectric material and the organic solvent is a sol in which the ceramic powder is dispersed in the form of solid particulates. As such, the ceramic powder and the organic solvent are admixed at a ratio by wt % of 20-40:60-80. When the ceramic powder is used in an amount less than 20 wt %, a dielectric layer may be formed to be too thin when only coating once. Meanwhile, if the above amount exceeds 40 wt %, the resultant dielectric layer may be non-uniform in the thickness range of ones of μm. As a polymeric sol useful in the present invention, the (1) polymeric sol is adopted, and description therefor is omitted. The particulate sol and the polymeric sol are preferably mixed together at a ratio by wt % of 55-75:25-45.

(4) Polymer-Added Hybrid Sol

This hybrid sol includes the (2) polymer-added polymeric sol, instead of the (1) polymeric sol used in the (3) hybrid sol, and the particulate sol. Preferably, the polymer-added hybrid sol is composed of 55-75 wt % particulate sol and 25-45 wt % polymer-added polymeric sol.

To the (1) polymeric sol, the (2) polymer-added polymeric sol, the (3) hybrid sol, and the (4) polymer-added hybrid sol, the organic additive is added to act as the auxiliary ingredient of the dielectric ceramic. The auxiliary ingredient of dielectric ceramic of BaTiO₃ is known to be Si, Mg, Mn, Y, Ca, etc. In particular, the auxiliary ingredient is used in an organic additive type dissoluble in the organic solvent of the sol. The amount of the organic additive is controlled to correspond to the required amount of the auxiliary ingredient in the dielectric ceramic. Specifically, the organic additive is described below.

The sol of the present invention includes two kinds of organic solvents. That is, the organic solvent used in the polymeric sol is classified into acetic acid which is a solvent of a barium precursor and an alcoholic solvent employed in the other case. Hence, the organic additive dissolved in the above organic solvent acts as the auxiliary ingredient in the dielectric ceramic.

When the BaTiO₃ based dielectric ceramic is prepared using a sol-gel process, a starting material for a main ingredient is selected from among the (1) polymeric sol, the (2) polymer-added polymeric sol, the (3) hybrid sol, and the (4) polymer-added hybrid sol. The organic additive may be used at any stage for convenience in the sol preparation process, and the kind thereof is determined depending on the kind of organic solvent used in the sol.

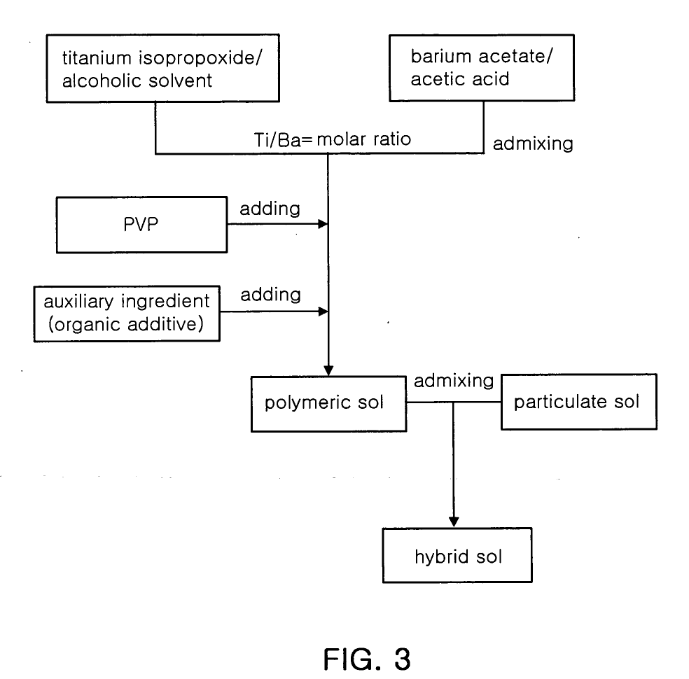

FIG. 3 shows the process of preparing the hybrid sol. In cases where the organic additive is added to the polymeric sol, it may be added to a barium precursor solution, a titanium precursor solution, or an admixture thereof (polymeric sol). As such, it is noted that the addition of the organic additive to the barium precursor solution requires an organic additive dissolved in an acetic acid solvent. Besides, when the alcoholic solvent is used, the organic additive of the auxiliary ingredient dissolved in alcohol is used. In general, organic additives dissolved in acetic acid are known to be dissolved in alcohols.

Thus, the sol having the organic additive acting as the auxiliary ingredient is applied, thereby manufacturing the dielectric ceramic. As such, the manufacturing process includes a series of processes of forming, drying and sintering of the dielectric layer. The forming process of the dielectric layer is preferably exemplified by a spin coating process. The method of manufacturing the MLCC by spin coating using the sol is in accordance with the prior technique.

The sol composition for dielectric ceramic of the present invention includes any one selected from among the (1) polymeric sol, the (2) polymer-added polymeric sol, the (3) hybrid sol, and the (4) polymer-added hybrid sol. Further, the amount of the organic additive acting as the auxiliary ingredient of the dielectric ceramic corresponds to the required amount of the auxiliary ingredient of the dielectric ceramic. Also, in the sol composition for BaTiO₃ based dielectric ceramic, the auxiliary ingredient includes, but is not limited to, representative kinds thereof as mentioned below, which are used in an organic additive type. Any kind of auxiliary ingredient may be applied in the present invention so long as it may exhibit the functions required of an auxiliary ingredient for BaTiO₃ based dielectric ceramic. In such cases, the point is that the addition type thereof should be an organic additive type dissolved in the organic solvent of the sol.

The auxiliary ingredient of the BaTiO₃ based dielectric ceramic is known to be Si, Mg, Mn, Y, or Ca. Also, functions and amounts of the above auxiliary ingredients are widely known in BaTiO₃ based dielectric ceramic, and are summarized as follows. Si functions to decrease a sintering temperature to about 1200° C. or less so as to make low temperature sintering possible. Si is used in an amount of 1-3 parts by weight based on 100 parts by weight of BaTiO₃. Mg functions to prevent the particulate growth of BaTiO₃ and help the ceramic particulates form shells thereof so that the other auxiliary ingredient cannot be diffused in cores of the ceramic particulates, thereby increasing a sintered density. Further, this element is used to make low temperature sintering possible, too. Mg is used in an amount of 1-3 parts by weight based on 100 parts by weight of BaTiO₃. Mn functions to inhibit the creation of oxygen vacancies and electrons upon sintering, so that insulation resistance does not decrease and high temperature IR increases. Mn is used in an amount of 0.5-2 parts by weight based on 100 parts by weight of BaTiO₃. Y functions to reduce the mobility of oxygen ions so as to provide high reliability for a long period, and increase TCC and BDV (Break Down Voltage). Y is used in an amount of 2-5 parts by weight based on 100 parts by weight of BaTiO₃. Ca functions that oxygen vacancies, which incur ionic conductivity to result in a reduced dielectric lifetime, are occupied by calcium ions. Ca is used in an amount of 0.05-2 parts by weight based on 100 parts by weight of BaTiO₃.

In the above mentioned auxiliary ingredients, Si and Mg are always added, and also, any one selected from among Mn, Y, Ca, and combinations thereof is further added. In the case of containing all of the auxiliary ingredients mentioned above, the TCC characteristic satisfies X5R (±15% at −55 to 85° C.) of the EIA standard. Alternatively, Y may be always added, or be replaced by a rare earth element.

The sol composition for dielectric ceramic includes an Si organic additive and an Mg organic additive dissolved in the organic solvent of the sol in the above four sol compositions, in which the amount of the Si organic additive and the amount of the Mg organic additive correspond to the required amounts of the auxiliary ingredients of the dielectric ceramic. Also, the sol composition further comprises an Mn organic additive, a Y organic additive and a Ca organic additive, in which the amounts of these organic additives correspond to the required amounts of the auxiliary ingredients of the dielectric ceramic.

The organic additive acting as the auxiliary ingredient in the dielectric ceramic should be dissolved in the organic solvent of the sol so that it is present in liquid phase in the sol. That is, the organic additive dissoluble in the alcoholic solvent or the acetic acid solvent is used. The organic additive which is dissolved in the alcoholic solvent is exemplified as follows. The Si organic additive is preferably selected from among tetramethyl orthosilicate, tetraethyl orthosilicate, silicon tetraacetate, and tetraethylsilane. The Mg organic additive is preferably selected from among magnesium ethoxide, magnesium nitrate hexahydrate, magnesium acetate tetrahydrate, magnesium acetylacetonate dihydrate, magnesium bishydrate, magnesium citrate, and magnesium methoxide. The Mn organic additive is preferably selected from among manganese acetate dihydrate, manganese (II) acetate, manganese (II) acetate tetrahydrate, and manganese (II) acetylacetonate. The Y organic additive is preferably selected from among yttrium acetate hydrate, yttrium acetylacetonate, yttrium acetylacetonate hydrate, yttrium butoxide, yttrium 2-ethylhexanoate, yttrium isopropoxide, and yttrium isopropoxide oxide. The Ca organic additive is preferably selected from among calcium acetate hydrate, calcium acetate monohydrate, calcium acetylacetonate hydrate, calcium tetramethyl heptanedionate, calcium citrate tetrahydrate, calcium cyclohexanebutyrate, calcium 2-ethylhexanoate, calcium isopropoxide and calcium methoxide.

The amount of the organic additive is determined to correspond to the required amount of the auxiliary ingredient in the dielectric ceramic. That is, in the case of the hybrid sol, based on 100 parts by weight of BaTiO₃ of the polymeric sol and BaTiO₃ of the particulate sol, the amount of the organic additive is determined to correspond to the required amount of the auxiliary ingredient in the dielectric ceramic. Such an amount is stoichiometrically calculated, which is specifically illustrated in Example, later.

The composition of the hybrid sol for dielectric ceramic includes 100 parts by weight of BaTiO₃ as the main ingredient, and, as the auxiliary ingredient, 1-3 parts by weight of Si, 1-3 parts by weight of Mg, 0.5-2 parts by weight of Mn, 2-5 parts by weight of Y and 0.05-2 parts by weight of Ca. Specifically, when the sum of the hybrid sol (the mixture of polymeric sol and particulate sol) and the organic additive meets 100 wt %, the organic additive has 0.3-1 wt % Si organic additive, 0.2-0.7 wt % Mg organic additive, 0.05-0.2 wt % Mn organic additive, 0.3-1 wt % Y organic additive and 0.01-0.03 wt % Ca organic additive, and the hybrid sol has the balance. At this time, the amount of the organic additive is controlled to correspond to the required amount of the auxiliary ingredient in the dielectric ceramic.

Below, an MLCC, as an example of chip components manufactured according to the present invention, is described. The sol composition of the present invention is formed into an ultrathin dielectric film by a spin coating process. The MLCC includes a multilayered ceramic sintered body, and outer electrodes electrically connected to inner electrodes of the multilayered sintered body. The dielectric ceramic layer of the sintered body has a thickness of 0.2-3 μm, and is layered to 10 layers or more. The inner electrodes are formed of Ni, Cu or alloys thereof, while the outer electrodes are formed of Cu or alloys thereof. The MLCC of the present invention has no pillowing phenomenon. The multilayered body of the present invention is manufactured using a spin coating process, in accordance with a method disclosed in Korean Patent Application No. 2003-91591. In the present invention, the auxiliary ingredient in the dielectric of the MLCC is provided by the organic additive dissoluble in the organic solvent of the sol.

A better understanding of the present invention may be obtained in light of the following examples which are set forth to illustrate, but are not to be construed to limit the present invention.

### EXAMPLE 1

1^{st} Step: Preparation of Polymeric Sol

A titanium precursor solution was admixed with a barium precursor solution to obtain a molar ratio of 1:1 of Ti to Ba. The barium precursor solution was prepared by dissolving 2.34 g of barium acetate in 3.52 g of acetic acid, followed by being stirred, and the titanium precursor solution was prepared by adding 2.58 g of titanium isopropoxide to 20 g of 2-methoxy ethanol. The above two solutions were admixed while the barium acetate solution was added one droplet at a time to the titanium isopropoxide solution. Then, the resultant admixture was further mixed for 1 hour, after which acetylacetone as a reaction inhibitor was added to provide a pH of 4.3, so as to ensure the reaction stability. Further, 0.3 g of polyvinylpyrrolidone as a polymer material was added to the admixture, followed by being stirred for about 45 min, to obtain a desired polymeric sol.

2^{nd} Step: Preparation of Particulate Sol

31.07 g of BaTiO₃ powder having an average particulate size of 0.2 μm were admixed with 67.8 g of 2-methoxy ethanol (2-MOE), to prepare a desired particulate sol.

3^{rd} Step: Preparation of Hybrid Sol

98.87 g of particulate sol and 67.8 g of polymeric sol were mixed together, after which the resultant mixture was loaded into a ball mill, and then a ball milling process was performed at 200 rpm for 6 hours, to prepare a hybrid sol (comparative example). Separately, 98.87 g of particulate sol was mixed with 67.8 g of polymeric sol to obtain a mixture, to which 0.7565 g of silicon tetraacetate and 0.4389 g of magnesium acetate tetrahydrate were added. The resultant mixture was loaded into a ball mill, and then a ball milling process was performed at 200 rpm for 6 hours, to prepare a hybrid sol (inventive example). Herein, to determine the amount of organic additive used as a starting material for an auxiliary ingredient in the dielectric ceramic, the amount of BaTiO₃ in the hybrid sol should be measured. This is because the amount of the organic additive corresponds to the required amount of the auxiliary ingredient, based on the above measured amount of BaTiO₃. Thus, in the case where 4% BaTiO₃ is included in the polymeric sol, the amount of BaTiO₃ obtained from the polymeric sol is calculated to be 2.71 g (67.8 g*0.04), which then adds 31.07 g of BaTiO₃ in the particulate sol, resulting in BaTiO₃ in the hybrid sol amounting to 33.78 g.

The hybrid sol was manufactured into a disc sample, which was then sintered at 1200° C. for 2 hours to obtain a dielectric body, on which outer electrodes were formed. The dielectric body was observed by an electron microscope and measured for TCC and sintered density.

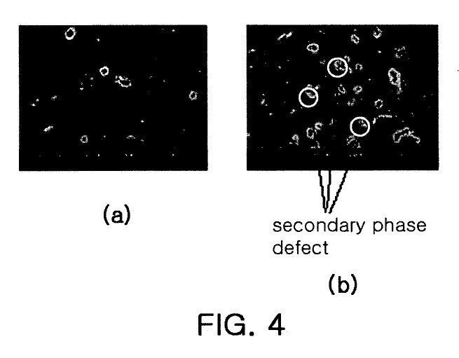

The electron micrographs are shown in FIGS. 4a and 4b, in which FIG. 4a shows the hybrid sol having an organic additive according to the present invention, and FIG. 4b shows the hybrid sol having no organic additive. From these results, it can be seen that the hybrid sol having no organic additive obtained in the comparative example has many defects.

Meanwhile, a plurality of samples was manufactured using the hybrid sol obtained in the inventive example according to the present invention, and measured for a sintered density. The values of sintered density of the plurality of samples are averaged, and given in Table 1, below.

TABLE 1
Sintered Density
95.55

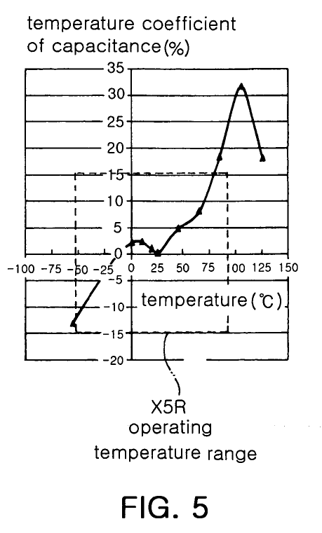

FIG. 5 is a graph showing the TCC of the samples according to the present invention. As is apparent from FIG. 5, although the TCC meets ±15% in an operating temperature range of −55 to 75° C., it exceeds 15% in the temperature range higher than 75° C.

### EXAMPLE 2

To the hybrid sol obtained in the inventive example of Example 1 of the present invention, 0.1403 g of manganese (II) acetate tetrahydrate, 0.8158 g of yttrium 2-ethylhexanoate and 0.0252 g of calcium acetate tetrahydrate were added, to manufacture a disc sample, which was then sintered at 1200° C. for 2 hours to obtain a dielectric body. Subsequently, outer electrodes were formed on the dielectric body. The dielectric body was measured for a sintered density, a dielectric constant and TCC characteristic, and was observed by an electron microscope. The values of sintered density and dielectric constant of the plurality of samples are averaged, and given in Table 2, below.

TABLE 2

| Sintered Density (Relative density % | |
|---|---|
| to BT Theoretical Density) | Dielectric Constant |
| 95.4 | 2207 |

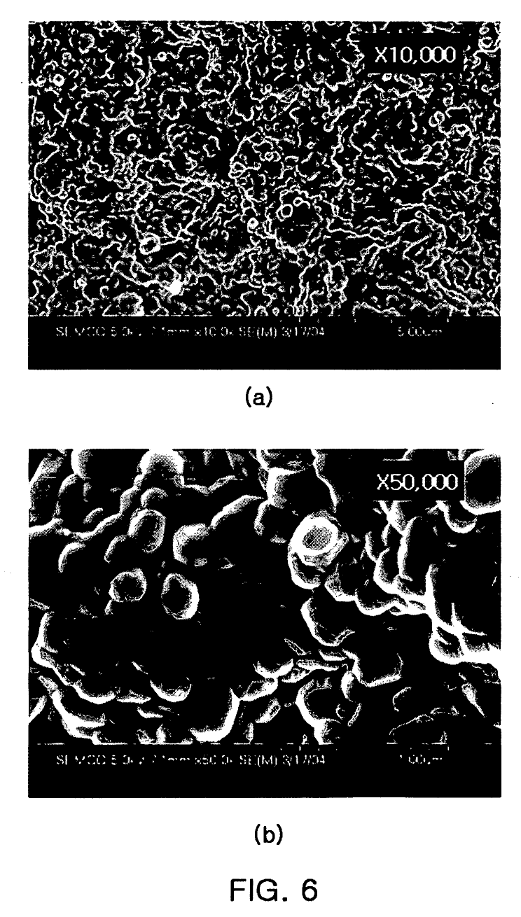

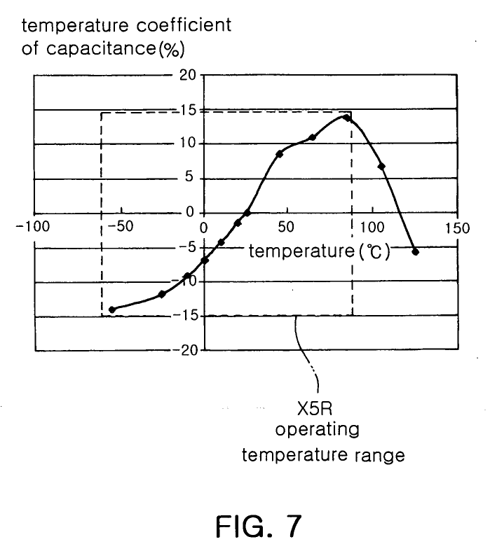

From the 10,000 and 50,000 magnifications from electron micrographs in FIGS. 6a and 6b, respectively, it can be shown that the samples according the present invention have uniform particulate growth and no pores. Further, in FIG. 7, it appears that the TCC characteristics of the samples are within ±15% in an operating temperature range of −55 to 85° C.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, Si, Mg, Mn, Y, or Ca may be used as an auxiliary ingredient in BaTiO₃ based dielectric ceramic of the present invention, however any other auxiliary ingredients, apart from the above ingredients, may be used in an organic additive type dissolved in the organic solvent of the sol for dielectric ceramic.

As described hereinbefore, the present invention provides a sol composition for dielectric ceramic, and dielectric ceramic and an MLCC using the same. In the present invention, when the dielectric ceramic is manufactured using a sol-gel process, the auxiliary ingredient is added in an organic additive type, which is dissolved in the organic solvent of the sol, thereby realizing the homogeneity of the sol and assuring the properties of the dielectric ceramic.

What is claimed is:

1. A sol composition for dielectric ceramic comprising BaTiO₃ as a main ingredient, and an auxiliary ingredient, comprising:
a polymeric sol including a metal precursor solution of BaTiO₃ and an organic solvent; and
an organic additive dissolved in the organic solvent to act as the auxiliary ingredient, in which the amount of the organic additive corresponds to a required amount of the auxiliary ingredient of the dielectric ceramic.

2. The sol composition as set forth in claim 1, wherein the auxiliary ingredient of the dielectric ceramic comprises at least one selected from among 1-3 parts by weight of Si, 1-3 parts by weight of Mg, 0.5-2 parts by weight of Mn, 2-5 parts by weight of Y, and 0.05-2 parts by weight of Ca, based on 100 parts by weight of BaTiO₃, and
the organic additive comprises at least one selected from among an Si organic additive, an Mg organic additive, an Mn organic additive, a Y organic additive and a Ca organic additive.

3. The sol composition as set forth in claim 1, wherein the auxiliary ingredient of the dielectric ceramic comprises 1-3 parts by weight of Si and 1-3 parts by weight of Mg, based on 100 parts by weight of BaTiO₃, and
the organic additive comprises an Si organic additive and an Mg organic additive.

4. The sol composition as set forth in claim 1, wherein the auxiliary ingredient of the dielectric ceramic comprises 1-3 parts by weight of Si, 1-3 parts by weight of Mg, 0.5-2 parts by weight of Mn, 2-5 parts by weight of Y and 0.05-2 parts by weight of Ca, based on 100 parts by weight of BaTiO₃, and
the organic additive comprises an Si organic additive, an Mg organic additive, an Mn organic additive, a Y organic additive and a Ca organic additive.

5. The sol composition as set forth in claim 1, further comprising a particulate sol including ceramic powder of BaTiO₃ and an organic solvent to be mixed with the polymeric sol.

6. The sol composition as set forth in claim 5, wherein the particulate sol and the polymeric sol are mixed at a ratio by wt % of 55-75:25-45.

7. The sol composition as set forth in claim 5, wherein the sum of the polymeric sol, the particulate sol, and the organic additive is 100 wt %, and
the organic additive comprises 0.3-1 wt % Si organic additive, 0.2-0.7 wt % Mg organic additive, 0.05-0.2 wt % Mn organic additive, 0.3-1 wt % Y organic additive and 0.01-0.03 wt % Ca organic additive.

8. The sol composition as set forth in claim 1, wherein the polymeric sol further comprises any one polymer material selected from among polyvinyl pyrrolidone, polyacrylic acid, benzaldehyde, and p-hydroxy benzoic acid.

9. The sol composition as set forth in claim 1, wherein the polymeric sol comprises 5-10 wt % barium acetate, 5-10 wt % titanium isopropoxide, 40-65 wt % alcoholic solvent, 15-30 wt % acetic acid, 3-10 wt % reaction stabilizer, and 0.5-5 wt % polymer material.

10. The sol composition as set forth in claim 5, wherein the particulate sol comprises 20-40 wt % BaTiO₃ powder and 60-80 wt % alcoholic solvent.

11. The sol composition as set forth forth in claim 4, wherein the Si organic additive is selected from among tetramethyl orthosilicate, tetraethyl orthosilicate, silicon tetraacetate, and tetraethylsilane.

12. The sol composition as set forth forth in claim 4, wherein the Mg organic additive is selected from among magnesium ethoxide, magnesium nitrate hexahydrate, magnesium acetate tetrahydrate, magnesium acetylacetonate dihydrate, magnesium bishydrate, magnesium citrate, and magnesium methoxide.

13. The sol composition as set forth forth in claim 4, wherein the Mn organic additive is selected from among manganese acetate dihydrate, manganese (II) acetate, manganese (II) acetate tetrahydrate, and manganese (II) acetylacetonate.

14. The sol composition as set forth forth in claim 4, wherein the Y organic additive is selected from among yttrium acetate hydrate, yttrium acetylacetonate, yttrium acetylacetonate hydrate, yttrium butoxide, yttrium 2-ethylhexanoate, yttrium isopropoxide, and yttrium isopropoxide oxide.

15. The sol composition as set forth forth in claim 4, wherein the Ca organic additive is selected from among calcium acetate hydrate, calcium acetate monohydrate, calcium acetylacetonate hydrate, calcium tetramethyl heptanedionate, calcium citrate tetrahydrate, calcium cyclohexanebutyrate, calcium 2-ethylhexanoate, calcium isopropoxide and calcium methoxide.

16. A dielectric ceramic, which is manufactured from the sol composition of claim 1.

17. A multilayered ceramic capacitor, comprising a plurality of dielectric ceramic layers, inner electrodes formed between the dielectric ceramic layers, and outer electrodes electrically connected to the inner electrodes, wherein each of the plurality of dielectric ceramic layers is formed of the dielectric ceramic of claim 16.
